(19) United States
(12) Patent Application Publication
(10) Pub. No.: US 2026/0196772 A1
(43) Pub. Date: Jul. 9, 2026

(54) CABLE CONNECTION DETECTION FOR ELECTRONIC DEVICES

(71) Applicant: Aivres Systems Inc., Fremont, CA (US)

(72) Inventor: Yu Cheng LAI, New Taipei City (TW)

(21) Appl. No.: 19/556,762

(22) Filed: Mar. 4, 2026

(51) Int. Cl. H01R 13/641; G06K 7/10; H01R 13/66; H01R 13/717

(52) U.S. Cl. CPC H01R 13/641; G06K 7/10316; H01R 13/6683; H01R 13/717

(57) ABSTRACT

A system includes a cable and an electronic device. The electronic device includes a first connector having a first connector interface, a radio frequency identification (RFID) reader, an antenna electrically coupled to the RFID reader and disposed proximate to the first connector interface, and a management controller communicatively coupled to the RFID reader. The cable includes a second connector having a second connector interface configured to mate with the first connector interface, and an RFID tag disposed proximate to the second connector interface. When the second connector interface is mechanically coupled to the first connector interface in a mated configuration, the RFID reader wirelessly communicates with the RFID tag via the antenna to generate an RFID signal. The management controller determines a connection state between the first and second connectors based at least on the RFID signal and generates an output signal indicating the connection state.

### TECHNICAL FIELD

The present disclosure generally relates to electronic devices and systems and, more specifically, to techniques for detecting and characterizing cable connections for electronic devices and systems.

### BACKGROUND

Modern electronic systems, such as high-performance computing platforms, often rely on complex architectures involving multiple interconnected components. To facilitate data and power transfer between these modules, multiple internal and/or external cables are used. Correct and reliable cable connections are important for the function, performance, and reliability of the electronic systems.

### SUMMARY

The present disclosure describes devices, circuits, systems, methods, and techniques for detecting and characterizing cable connection states in a system including one or more electronic devices.

In one aspect, a system is described that includes an electronic device and a cable. The electronic device includes a first connector having a first connector interface, an RFID reader, an antenna electrically coupled to the RFID reader and disposed proximate to the first connector interface, and a management controller communicatively coupled to the RFID reader. The cable includes a second connector having a second connector interface configured to mechanically mate with the first connector interface and an RFID tag disposed proximate to the second connector interface. When the second connector interface is mechanically coupled to the first connector interface in a mated configuration, the RFID reader is configured to wirelessly communicate with the RFID tag via the antenna, and the management controller is configured to generate an output signal indicating a state of a connection between the first connector and the second connector based at least on an RFID signal from the RFID reader.

In some implementations, the second connector includes a first metal shield disposed over the RFID tag, and the metal shield defines a first opening oriented toward the antenna when the second connector interface is coupled with the first connector interface in the mated configuration. In some cases, the electronic device further includes a second metal shield covering the antenna, and the second metal shield defines a second opening oriented toward the first opening such that the RFID tag communicates with the antenna through the first opening and the second opening.

In some implementations, the antenna is disposed within a distance to the first connector interface, where the distance is within a communication range of the antenna.

In some implementations, the RFID tag is configured to be powered by an electromagnetic field generated by the antenna.

In some implementations, the RFID reader is configured to generate the RFID signal to indicate whether a matching RFID tag is detected. In some implementations, the RFID signal includes a tag identifier corresponding to an identifier of a detected RFID tag, and the management controller is configured to determine whether the tag identifier matches an expected identifier associated with the first connector and to generate the output signal to include a flag indicating a matched condition or an unmatched condition.

In some implementations, the electronic device further includes a pressure sensor positioned proximate to the first connector interface. The pressure sensor can be configured to detect a physical force applied by the second connector and to generate a sensor signal indicative of an insertion status of the second connector based on the detected physical force.

In some implementations, the management controller is configured to generate the output signal based on both the RFID signal and the sensor signal.

In some implementations, the pressure sensor includes a piezoresistive element having an electrical impedance that varies in response to the physical force.

In some implementations, the pressure sensor is mounted on a printed circuit board that supports the first connector and is positioned to be contacted by a portion of the second connector when the second connector is in the mated configuration.

In some implementations, the electronic device further includes a signal conditioning circuit electrically coupled between the pressure sensor and the management controller, and the signal conditioning circuit is configured to convert an analog output of the pressure sensor into the sensor signal.

In some cases, the signal conditioning circuit comprises an amplifier and an analog to digital converter (ADC).

In some implementations, the management controller is configured to determine the insertion status as one of not being inserted, being partially inserted, or being fully inserted based on the sensor signal satisfying one or more thresholds.

In some implementations, the management controller is configured to determine a reverse-insertion fault condition in response to (i) the sensor signal indicating the second connector is in a fully inserted state and (ii) the RFID signal indicating that the RFID tag is not detected.

In some implementations, the management controller is configured to generate the output signal indicating a valid connection state in response to (i) the sensor signal indicating that the second connector is in a fully inserted state and (ii) the RFID signal indicating that a matching RFID tag is detected.

In some implementations, the electronic device further includes an output component configured to receive the output signal from the management controller and to provide an indication of the state of the connection based on the received output signal. The output component can include one or more of: one or more light indicators, a display device, an audible output device, or a network interface configured to transmit the output signal to a remote device.

In some implementations, the output component is a first output component, and the electronic device includes a first circuit board with the first connector, the RFID reader, and the antenna integrated thereon; a second circuit board with a third connector, a second RFID reader, and a second antenna integrated thereon, where the third connector is configured to be connected with a fourth connector of a second cable; a second output component configured to receive a second output signal from the management controller to provide an indication of a state of connection between the third connector and the fourth connector; and an electrical board with the management controller, the first output component, and the second output component integrated thereon. In some cases, the first circuit board and the second circuit board are integrated on the electrical board.

In some implementations, the electronic device includes a computing system, and the management controller is implemented by a baseboard management controller (BMC) of the computing system.

In another aspect, the present disclosure describes an electronic device including a first connector having a first connector interface configured to mechanically mate with a second connector interface of a cable, an RFID reader, an antenna electrically coupled to the RFID reader and disposed proximate to the first connector interface (and configured to wirelessly communicate with an RFID tag of the cable in a mated configuration), and a management controller communicatively coupled to the RFID reader. The management controller is configured to generate an output signal indicating a state of a connection between the first connector and the cable based at least on an RFID signal received from the RFID reader identifying the RFID tag.

In some implementations, the antenna is configured to face a first opening of a first metal shield disposed over the RFID tag when the first connector interface is in a mated configuration with the second connector interface.

In some cases, the electronic device further comprises a second metal shield covering the antenna, and the second metal shield defines a second opening oriented toward the first opening of the first metal shield such that the RFID tag communicates with the antenna through the first opening and the second opening.

In some implementations, the antenna is disposed within a first distance to the first connector interface, and the first distance is within a communication range of the antenna.

In some implementations, the antenna is configured to generate an electromagnetic field that powers the RFID tag when the first connector interface is in a mated configuration with the second connector interface.

In some implementations, the RFID reader is configured to generate the RFID signal to indicate whether a matching RFID tag is detected by the RFID reader.

In some implementations, the RFID reader is configured to generate the RFID signal to include a tag identifier corresponding to an identifier of a detected RFID tag.

In some cases, the management controller is configured to determine whether the tag identifier matches an expected identifier associated with the first connector, and to generate the output signal to include a flag indicating a matched condition or an unmatched condition.

In some implementations, the electronic device further comprises a pressure sensor positioned proximate to the first connector interface, and the pressure sensor is configured to detect a physical force applied by the second connector and generate a sensor signal indicative of an insertion status of the second connector based on the detected physical force, and the management controller is configured to generate the output signal based on both the RFID signal and the sensor signal.

In some cases, the pressure sensor comprises a piezoresistive element having an electrical impedance that varies in response to the physical force applied by the second connector.

In some cases, the pressure sensor is mounted on a printed circuit board that supports the first connector, and is positioned to be contacted by a portion of the second connector when the second connector is in the mated configuration.

In some cases, the electronic device further comprises a signal conditioning circuit electrically coupled between the pressure sensor and the management controller, and the signal conditioning circuit is configured to convert an analog output of the pressure sensor into the sensor signal.

In some cases, the signal conditioning circuit comprises an amplifier and an analog to digital converter (ADC).

In some cases, the management controller is configured to determine the insertion status as one of not being inserted, being partially inserted, or being fully inserted based on the sensor signal satisfying one or more thresholds.

In some cases, the management controller is configured to determine a reverse-insertion fault condition in response to (i) the sensor signal indicating the second connector is in a fully inserted state, and (ii) the RFID signal indicating that the RFID tag is not detected.

In some cases, the management controller is configured to generate the output signal indicating a valid connection state in response to (i) the sensor signal indicating that the second connector is in a fully inserted state; and (ii) the RFID signal indicating that a matching RFID tag is detected.

In some implementations, the electronic device further comprises an output component configured to receive the output signal from the management controller and to provide an indication of the state of the connection based on the received output signal.

In some cases, the output component comprises one or more of: one or more light indicators, a display device, an audible output device, or a network interface configured to transmit the output signal to a remote device.

In some cases, the output component is a first output component, and the electronic device comprises: a first circuit board, wherein the first connector, the RFID reader, and the antenna are integrated on the first circuit board; a second circuit board, wherein a third connector, a second RFID reader, and a second antenna are integrated on the second circuit board, and the third connector is configured to be connected with a fourth connector of a second cable; a second output component configured to receive a second output signal from the management controller to provide an indication of a state of connection between the third connector and the fourth connector; and an electrical board, wherein the management controller, the first output component, and the second output component are integrated on the electrical board.

In some cases, the first circuit board and the second circuit board are integrated on the electrical board.

In some implementations, the electronic device comprises a computing system, and wherein the management controller is implemented by a baseboard management controller (BMC) of the computing system.

In another aspect, the present disclosure describes a method performed by an electronic device. The method includes detecting, by an RFID reader of the electronic device via an antenna, an RFID signal from an RFID tag of a cable; generating, by a management controller of the electronic device, an output signal indicating a state of a connection between the first connector and a second connector of the cable based at least on the RFID signal; and outputting, by an output component of the electronic device, an indication of the state of the connection.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### BRIEF DESCRIPTION OF DRAWINGS

FIG. 1 illustrates an example system that includes an electronic device and a cable.

FIG. 2A illustrates an example electronic device with cable connection detection.

FIG. 2B illustrates an example system including a server board for cable connection detection of electronic devices.

FIG. 3A illustrates a side view of an example connector assembly for cable connection detection on a printed circuit board (PCB).

FIG. 3B illustrates a cross-sectional diagram of an example pressure sensor used for detecting a physical force applied by a connector.

FIG. 4 is a flowchart illustrating an example process for monitoring a cable connection status.

FIG. 5 illustrates an example computing device.

FIG. 6 illustrates an example computing system.

Like reference numbers and designations in the various drawings indicate like elements.

### DETAILED DESCRIPTION

An electronic system, such as a computer server or a server cluster, can include one or more electronic devices and/or one or more other modules interconnected by a plurality of cables. The correctness and stability of these cables can affect the system performance and reliability of the electronic system. Conditions such as an incorrect cable installation, poor contact, or loosening, may contribute to abnormal operation or downtime. This vulnerability can be particularly acute in high-density server systems in which the cable count can reach dozens.

In some cases, cable connection confirmation rely on manual visual inspection and operator experience. Although Labeling, latching, or other keying features can be used to reduce the misconnection risk, such approaches may not provide real-time connection-state feedback and may not promptly reveal an abnormal condition until after the electronic system exhibits a fault. Maintenance personnel may need to check the cable connections one-by-one, which can be time-consuming and can increase maintenance effort and cost in complex systems.

Implementations of the present disclosure provide devices, systems, methods, and techniques that can automatically monitor cable connection status. In some implementations, a system uses a detection mechanism to determine whether a cable is connected to an intended location, whether a reverse insertion condition is present, and/or whether the insertion is complete. The techniques described herein can be applied to any appropriate types of cables used for data communication, signal transmission, and/or power supply, provided that the cable utilizes a physical connector interface. For example, the cable can be an electrical cable or an optical fiber cable. The detection mechanism can provide cable connection information as a signal to a server-side management system so that a user can obtain a cable connection status in real time and localize an abnormal cable for servicing.

The detection mechanism can support a cable identification using a radio frequency identification (RFID). For example, the cable can include an RFID tag circuit proximate to a cable connector, and a corresponding RFID reader circuit can be arranged at a board-side connector to support a one-to-one identification such that a correct cable can be sensed due to a match and an incorrect cable is not sensed due to a mismatch.

The RFID tag circuit and the corresponding RFID reader circuit may be configured for a short-range detection (e.g., within a few centimeters) by adjusting a coil and an impedance characteristic and reducing a coil area, which can reduce a likelihood of sensing an adjacent cable in a dense layout. In some cases, a metal shielding can be provided on the RFID tag circuit, with an opening at a sensing face, to control the sensing direction and the range. This can reduce an undesired sensing of the adjacent cable, and assist with determining whether a 180-degree reverse or a misaligned insertion condition is present.

Furthermore, in some implementations, the detection mechanism can support a connection confirmation by using a pressure sensor. For example, when the cable is inserted, the pressure sensor may experience an applied force and exhibit an impedance change. The system can include an amplifier and an analog-to-digital converter (ADC) to convert a sensor output into an electronic signal indicative of an insertion status.

The RFID reader can communicate with a baseboard management controller (BMC), e.g., via a serial peripheral interface (SPI), a general-purpose input/output (GPIO) interface, or another digital interface. The BMC can perform a logic evaluation and output the cable connection status. For example, an indicator (e.g., a light-emitting diode (LED)) can enable an operator to quickly identify an abnormal cable position and promptly address a detected issue.

The subject matter described in the present disclosure can be implemented in particular implementations so as to realize one or more of the following technical advantages, effects, and/or benefits.

For example, the described techniques can reduce manual inspection effort by providing an automated indication of a cable connection state, including whether a cable is fully inserted, partially inserted, connected to an intended port, or inserted in an unintended orientation. The described techniques can reduce machine damage risk associated with incorrect connections by enabling early detection of abnormal connection conditions before power-up, during bring-up, or during operation. The described techniques can shorten downtime associated with troubleshooting by enabling real-time connection-state monitoring and by providing localized indications (e.g., connector-adjacent indicators) that assist an operator in rapidly identifying a problem cable among a plurality of cables.

In some implementations, the described techniques can be implemented using a design that occupies limited circuit board space and is adaptable to different connector types and system requirements. For example, a pressure sensor can be integrated into a physical connector interface via custom tooling, or added as an external sensor module, film, or bracket disposed around or under the physical connector interface. In some implementations, short-range identification and connector-localized indication can support high-density layouts by reducing ambiguity among adjacent cables and enabling targeted servicing without extensive cable tracing.

Example application scenarios include assembly verification, factory test, field servicing, and ongoing monitoring for a server cluster or server platform having a plurality of internal cables between boards, as well as other multi-module electronic systems in which cable installation density and access constraints can make manual checking less efficient, such as network switches, storage systems, telecommunications equipment, industrial control systems, and/or other rack-mounted computing or electronic platforms.

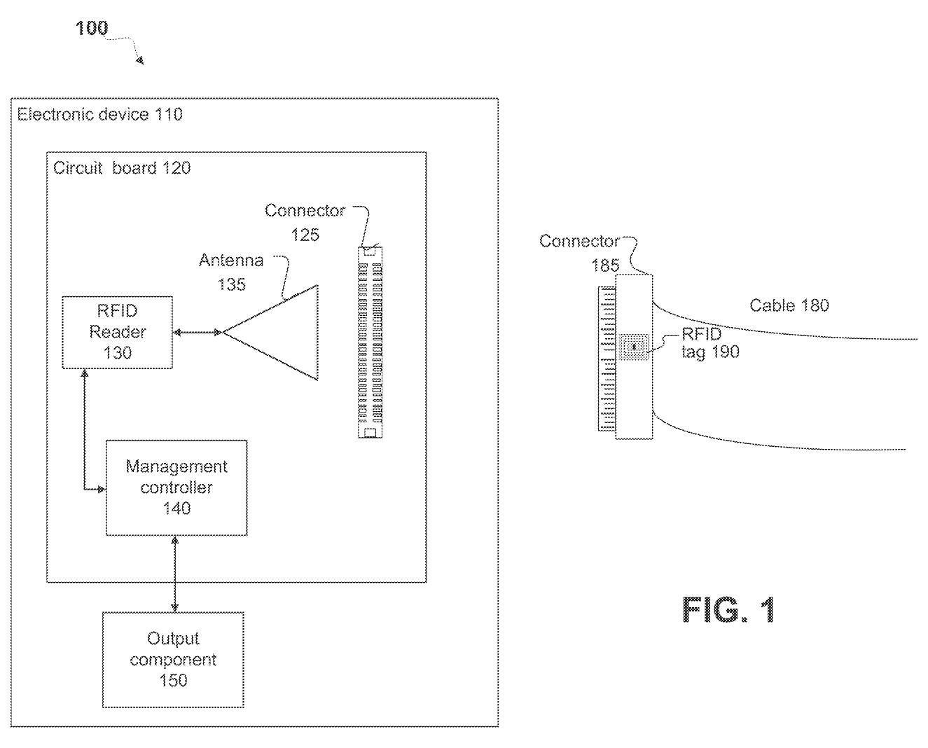

FIG. 1 illustrates an example system 100 that includes an electronic device 110 and a cable 180. The electronic device 110 can be any type of electronic device, for example, a server device, a network switch, a processing device, a storage device, a telecommunications device, an industrial control device, or another multi-module electronic platform that utilizes one or more cables to couple internal or external components. In some implementations, the electronic device 110 can be a computing system, e.g., a personal computer, an individual computer server, a compute node in a server cluster, a rack-mounted server cluster, or another computing platform. The cable 180 can be any type of cable for connecting components of the electronic device 110, or for connecting the electronic device 110 to an external device or module. For example, the cable 180 can be a board-to-board cable, a power cable, a data cable, or a mixed-signal cable.

In the example shown in FIG. 1, the electronic device 110 includes a circuit board 120 and a first connector 125 mounted on the circuit board 120. The electronic device 110 can further include one or more electronic components (e.g., a processing unit, a storage unit, a network unit, and/or a control unit) integrated on the circuit board 120. The first connector 125 can be configured to receive a second connector 185 located at a terminal end of the cable 180. The first connector 125 and the second connector 185 can be any appropriate types of connectors that are configured to mate with one another to form one or more electrical and/or optical communication paths between the circuit board 120 and the cable 180. The communication paths formed by the connectors can be used for data communication, signal transmission, and/or power supply. In an illustrative example, the first connector 125 can include a receptacle housing with a plurality of contacts, and the second connector 185 can include a plug housing with corresponding contacts that engage the contacts of the first connector 125 when the connectors are in a mated configuration. In other examples, the first connector 125 and the second connector 185 can include a board-to-cable plug/receptacle pair, a header-and-socket pair, a card-edge connector, a mezzanine connector, a ribbon cable connector, a coaxial connector, or another multi-contact connector. In some cases, the connectors can conform to a standardized interface, e.g., a Peripheral Component Interconnect Express (PCIe) interface, a Serial Advanced Technology Attachment (SATA) interface, a Serial Attached SCSI (SAS) interface, a Universal Serial Bus (USB) interface, an Ethernet interface, and so on. In some cases, the connectors can implement a customized pinout. Furthermore, in some cases, the first connector 125 and the second connector 185 can include one or more mechanical alignment features (e.g., a guide rail, a keying feature, a latch, or a retention clip) that assist with engaging the connectors in a mated configuration.

To determine whether the cable 180 is correctly connected at the first connector 125, the system 100 can use radio frequency identification (RFID) to detect the presence and identity of the cable 180. In this approach, an RFID tag 190 positioned at (or near) the second connector 185 of the cable 180 can be wirelessly read when the two connectors are mated. RFID can provide a contactless detection mechanism that is fast and does not require visual access to the connector interface. RFID can also enable reliable cable identification in high-density assemblies, for example, by using a short read range that reduces a likelihood of reading adjacent cables. The cable 180 can include a plurality of terminal ends, and one or more of the plurality of terminal ends can include a respective connector and a respective RFID tag.

To perform wireless identification and connection sensing, the electronic device 110 can include an RFID reader 130 and an antenna 135 electrically coupled to the RFID reader 130. The antenna 135 can be disposed proximate to the first connector 125, for example, such that the antenna 135 is within a communication range of the tag 190 when the connectors are mated. In an illustrative example, the distance between the antenna 135 and the RFID tag 190, when the second connector 185 is fully seated in the first connector 125, can be less than about 50 mm. For example, the distance can be within about 1 mm to about 30 mm, within about 2 mm to about 20 mm, within about 5 mm to about 15 mm, or within about 8 mm to about 12 mm. In some implementations, the communication range can be selected to be relatively short (e.g., less than about 30 mm, less than about 20 mm, less than about 10 mm, or less than about 5 mm) to reduce the likelihood of sensing an adjacent RFID tag associated with an adjacent connector in a high-density layout. In other implementations, the communication range can be increased (e.g., up to about 50 mm) to improve read robustness in view of shielding, connector tolerances, or alignment variation.

The antenna 135 can be formed as a coil, such as a planar coil on the circuit board 120, a wire-wound coil, or a stamped-metal coil. The RFID reader 130 can be implemented by a dedicated integrated circuit or by a controller having RFID functionality. In some cases, the RFID reader 130 and the antenna 135 can be mounted on the circuit board 120. In some other cases, the RFID reader 130 and/or the antenna 135 can be mounted on a separate board or a separate subassembly coupled to the circuit board 120. The RFID reader 130 can communicate with a management controller 140 via a digital interface, e.g., a Serial Peripheral Interface (SPI), an Inter-Integrated Circuit (I2C), a Universal Asynchronous Receiver-Transmitter (UART), or another serial interface, and can provide, as an RFID signal, a binary detection indication, a decoded tag identifier, and/or other tag-related data to the management controller 140.

Correspondingly, the cable 180 can include an RFID tag 190 disposed proximate to the second connector 185. In some cases, the RFID tag 190 can be integrated into the cable 180, e.g., integrated within a housing of the second connector 185. In some other cases, the RFID tag 190 can be removably attached to the second connector 185 or a portion of cable 180 that is proximate to the second connector 185, for example, by an adhesive strip, a clip, a strap, a sleeve, a fastener, or another removable retention feature disposed on an exterior surface of the second connector 185 or the cable 180. In some examples, the RFID tag 190 can be removably attached such that a same cable 180 can be re-tagged for a different configuration, or such that the tag 190 can be replaced if damaged. The RFID tag 190 can be positioned such that, when the second connector 185 is mechanically mated with the first connector 125, the RFID tag 190 is disposed within the communication range of the antenna 135 (e.g., within a first distance of a few centimeters).

The RFID tag 190 can include an RFID integrated circuit (IC) and an antenna structure electrically coupled to the RFID IC. In some examples, the antenna structure is formed as a conductive loop, coil, trace pattern, or stamped-metal element configured to inductively and/or capacitively couple with an electromagnetic field generated by the antenna 135. The RFID tag 190 can be implemented on a flexible substrate (e.g., a label or flex circuit), on a rigid substrate (e.g., a small printed circuit board), or integrated into a molded connector component. The RFID IC can store a unique tag identifier (e.g., an electronic product code (EPC) or other identifier) and, in response to an inquiring signal from the RFID reader 130, can modulate a response (e.g., by load modulation/backscatter) that is detectable by the RFID reader 130 via the antenna 135. In some cases, the RFID tag 190 can include non-volatile memory that stores additional tag data, such as a cable type, a part number, a length, a manufacturing lot code, a compatibility class, a supported protocol, and/or other inventory information, and the RFID reader 130 can retrieve the tag data to facilitate cable identification and validation.

In some implementations, the RFID tag 190 can be a passive tag powered by an electromagnetic field generated by the antenna 135. A passive tag can reduce the cost and complexity of the cable assembly, avoid a battery or charging requirement, and improve long-term reliability and service life (e.g., by eliminating battery aging and maintenance). A passive tag can also be smaller and lighter, which can facilitate integration into a connector housing without significantly impacting mechanical fit, and can be well-suited for short-range, point-to-point identification in a high-density connector environment. In some other implementations, the RFID tag 190 can be an active tag (e.g., having a local power source) to support additional functionality, such as expanded memory, enhanced read robustness, and/or additional telemetry.

In some implementations, the system 100 is configured for a relatively short read range (e.g., approximately 1 cm or within a few centimeters), to reduce a likelihood of sensing an adjacent tag associated with an adjacent connector in a high-density layout. The short-range behavior can be achieved by selecting or tuning one or more of the coil geometry, the coil area, the coil inductance, the coupling coefficient, and the impedance characteristic of the antenna 135 and/or the RFID tag 190.

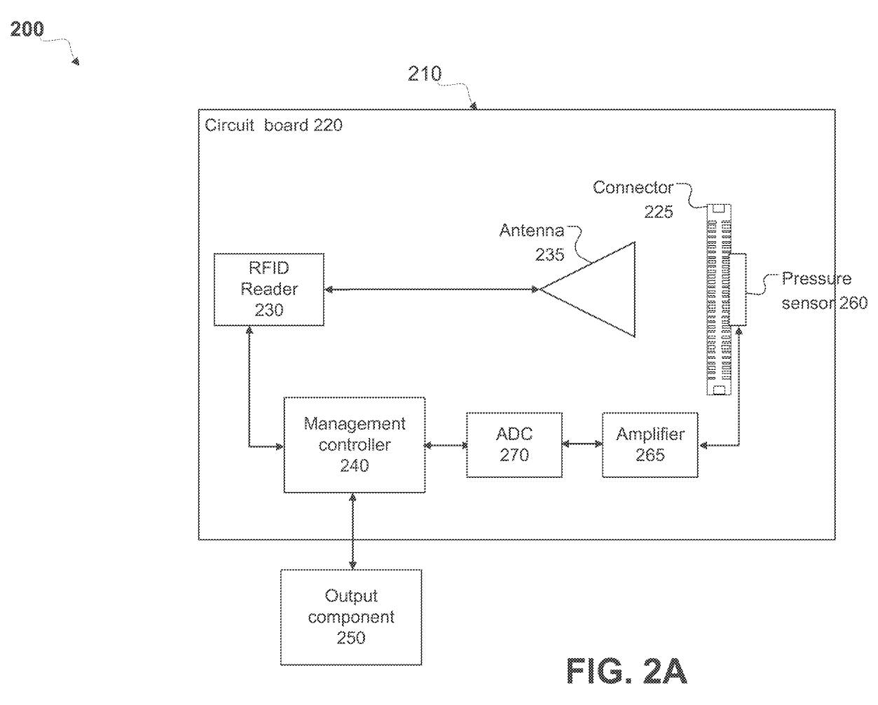

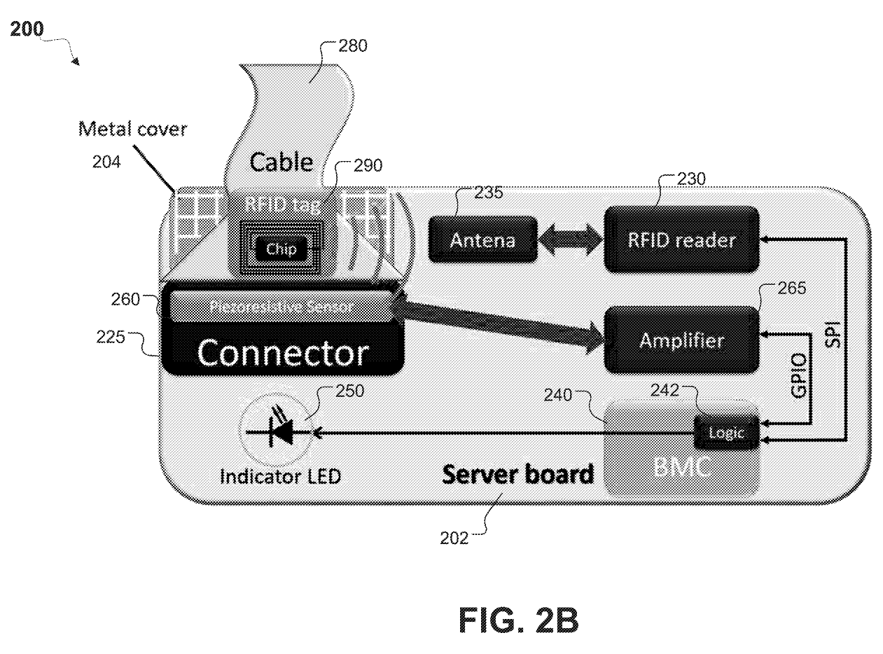

To further control the sensing direction and restrict the communication range, in some implementations, the second connector 185 of the cable 180 can include a metal shield (e.g., a metal cover as illustrated in FIG. 2B) disposed over or around the RFID tag 190. The metal shield can at least partially enclose the RFID tag 190. The metal shield can define an opening or window oriented toward the antenna 135 when the second connector interface is mechanically coupled with the first connector interface in the mated configuration. The metal shield can attenuate electromagnetic fields outside of the opening such that wireless communication between the antenna 135 and the RFID tag 190 primarily occurs through the opening when the second connector 185 is in a mated configuration with the first connector 125. In some cases, the antenna 135 can also be at least partially covered by a corresponding metal shield that defines a respective opening oriented toward the RFID tag 190. When the connectors are mated, the opening of the tag-side shield and the opening of the antenna-side shield can be positioned to face one another (e.g., substantially aligned along an axis extending through the connector interface), thereby forming a defined coupling path between the antenna 135 and the RFID tag 190.

The targeted shielding arrangement can effectively isolate the radio frequency signals and reduce undesired cross-talk with adjacent cables. Furthermore, the shield openings can increase directional selectivity such that, for example, a reverse or misaligned insertion condition results in reduced coupling and a “tag not detected” indication, thereby supporting detection of an abnormal connection condition.

The architecture of the RFID sensing assembly can be implemented in various reader and antenna configurations. In a one-to-one configuration, a single RFID reader 130 is coupled to a single antenna 135 to read a single RFID tag 190, ensuring one-to-one identification at a specific connection port. In this configuration, the RFID reader 130 can detect the presence of the cable 180, read a unique tag identifier, and/or determine whether the RFID tag 190 corresponds to an expected cable for the first connector 125. The RFID signal can indicate whether a matching RFID tag is detected and can include the unique tag identifier and/or a match indication.

Alternatively, the reader topology can support a multi-antenna configuration in which one central RFID reader 130 connects to multiple antennas, where each antenna 135 is disposed proximate to a respective connector interface, and the RFID reader 130 can sequentially (or selectively) read from the multiple antennas to detect respective RFID tags associated with respective connectors. The multi-antenna configuration enables the system to determine, for each connector, whether a tag is detected and whether the detected tag identifier matches an expected tag information (e.g., a mapping between a connector identifier and an expected tag identifier).

In some implementations, the electronic device 110 can further include the management controller 140 communicatively coupled to the RFID reader 130. The management controller 140 can be implemented, for example, by a baseboard management controller (BMC), a microcontroller, a system-on-chip (SoC), or another processing device or circuit. The management controller 140 can be configured to receive data from the RFID reader 130 and determine a connection state of the cable 180 based at least on the RFID signal. For example, the management controller 140 can receive, from the RFID reader 130, (i) a detection indication indicating whether a tag is present within a communication range of the antenna 135, (ii) a tag identifier of a detected tag, and/or (iii) other tag-related data stored in a memory of the RFID tag 190 (e.g., a cable type, part number, or compatibility class). In some implementations, the management controller 140 can maintain (e.g., store in memory) expected tag information for one or more connectors, such as a mapping between a connector identifier (or port identifier) and an expected tag identifier and/or expected tag attributes. The management controller 140 can compare the detected tag identifier (or tag attributes) to the expected tag information to determine whether a correct cable is connected at the first connector 125, and can determine one or more diagnostic states such as “no tag detected,” “unknown tag,” “wrong cable,” and/or “correct cable.” Based on the determined connection state, the management controller 140 can generate an output signal indicative of the state of the connection. The output signal can include one or more status flags, a connection-state code, a log entry, and/or a message to be transmitted to a remote device.

In implementations in which a single RFID reader 130 is coupled to multiple antennas 135 (e.g., via an antenna multiplexer, a switch network, or separate antenna ports of the RFID reader 130), the management controller 140 can further control and coordinate reading operations across the multiple antennas 135 and process the resulting data on a per-connector basis. For example, the management controller 140 can select an antenna index (e.g., corresponding to a particular connector/port), control the RFID reader 130 to perform an interrogation cycle using the selected antenna 135, and receive one or more read results (e.g., presence/no presence, tag identifier, received signal strength, error code) associated with that antenna. The management controller 140 can repeat the interrogation cycle for additional antennas 135 according to a polling schedule (e.g., sequentially, periodically, upon a detected event, or on demand), thereby generating a set of read results corresponding to a plurality of connectors.

In the one-reader-to-multiple-antenna configuration, the management controller 140 can maintain per-connector state data structures (e.g., a table indexed by connector identifier) that store, for each connector, an expected tag identifier, a most recently detected tag identifier, a match/mismatch status, a timestamp of the most recent successful read, and/or an error count. The management controller 140 can determine, for each connector, a connection state based on the corresponding read result and the expected tag information. For example, for a given connector, the management controller 140 can determine: (i) “disconnected” when no tag is detected for that connector, (ii) “connected--unknown” when a tag is detected but no expected information exists, (iii) “connected--wrong cable” when a detected tag identifier does not match the expected tag identifier for that connector, and (iv) “connected--correct cable” when the detected tag identifier matches the expected tag identifier.

Based on the per-connector connection states, the management controller 140 can generate one or more output signals. For example, the management controller 140 can generate a separate output signal for each connector, or generate an aggregated output message that includes the connection state for each of a plurality of connectors. The output can include per-connector status flags or codes, a system-wide health indicator derived from the per-connector states, a log entry identifying which connector is affected, and/or a message to be transmitted to a remote device (e.g., via a management network) for monitoring, alerting, inventory tracking, and/or service diagnostics.

An output component 150 can be coupled to the management controller 140 to receive the output signal and provide an indication of the state of the connection. The output component 150 can include, for example, one or more light indicators (e.g., one or more light-emitting diodes (LEDs) positioned proximate to the first connector 125), a display device, an audible output device, and/or a network interface configured to transmit the output signal to the remote device. The output component 150 can provide a localized indication that enables an operator to quickly identify a connector associated with an abnormal condition. The management controller 140 may additionally store a connection-state information in a memory and/or provide the connection-state information to an external management system for a monitoring, an alerting, an inventory tracking, an assembly verification, or a service diagnostic.

In some implementations, the electronic device 110 can include a multi-board computing platform in which multiple circuit boards are interconnected by one or more internal cables. For example, a first circuit board can be a CPU board that includes one or more first connectors, and a second circuit board can be a memory board or a GPU board that includes one or more second connectors configured to mate with corresponding cable connectors. An electrical board (e.g., a motherboard) can include (or be coupled to) the management controller 140 and can be communicatively coupled to one or more RFID readers and/or antennas associated with the first circuit board and/or the second circuit board, for example, via one or more serial interfaces, a shared management bus, and/or a sideband management link. In this multi-board configuration, one or more inter-board cables can include respective RFID tags proximate to respective cable connectors such that, when a cable connector is mated with a corresponding board connector, the associated RFID tag is within a communication range of a corresponding antenna. The management controller 140 can determine, for each inter-board connection, a connection state based on the corresponding RFID signal (and, optionally, based on one or more additional sensor signals as described herein) and can generate a respective output signal for each connection. For example, the management controller 140 can maintain a mapping between board identifiers and connector identifiers (e.g., CPU-board connector identifiers and GPU-board or memory-board connector identifiers) and expected tag identifiers, enabling detection of conditions such as a missing interconnect between the first and second circuit boards, an incorrect cable installed between the circuit boards, and/or an unknown cable, and can provide corresponding per-connection indications via the output component 150 and/or via a remote management interface.

In some implementations, the system 100 includes a plurality of electronic devices and a plurality of cables that each connect one or more electronic devices. The system 100 includes a management controller coupled to the plurality of electronic devices and configured to detect cable connections between the electronic devices and the cables. The management controller can be same as or similar to the management controller 140. Each electronic device can be similar to the electronic device 110, but without the management controller 140. Each cable can be same as or similar to the cable 180. The system 100 can further include a plurality of output components 150 coupled to the management controller. Each output component 150 can be used to indicate a respective cable connection between a corresponding electronic device and a corresponding cable.

FIG. 2A illustrates a schematic block diagram of an example system 200 including an example electronic device 210 with cable connection detection. The system 200 can be same as or similar to the system 100 of FIG. 1. The electronic device 210 can be an updated or expanded version of the electronic device 110 described with reference to FIG. 1. The electronic device 210 further includes a mechanical sensing capability that can be used, alone or in combination with RFID-based detection, to determine a cable connection state. The electronic device 210 can identify a condition such as a cable connector not being inserted, being partially inserted, being fully inserted, an incorrect cable being connected to a given connector, or a connector being inserted in an unintended orientation.

The electronic device 210 can include a circuit board 220, a connector 225 mounted on the circuit board 220, an RFID reader 230, and an antenna 235 electrically coupled to the RFID reader 230. The RFID reader 230 and the antenna 235 can be integrated on the circuit board 220. Similar to the implementation shown in FIG. 1, the antenna 235 and the RFID reader 230 can form an RFID detection path configured to wirelessly communicate with a cable-side RFID tag when the cable is connected with (e.g., inserted into) the connector 225. As described with reference to FIG. 1, the antenna 235 can be formed as a coil, and the RFID reader 230 can communicate with a management controller 240 (e.g., the management controller 140 of FIG. 1) via a digital interface to provide the RFID signal. The management controller 240 can be included in the electronic device 210 (as shown in FIG. 2A) or externally coupled to the electronic device 210.

The management controller 240 can include or access a mapping between a plurality of connectors and a plurality of expected tag identifiers to verify that an intended (or target) cable is connected to the connector 225. The management controller 240 may maintain an inventory record of a detected cable, log a connection-state transition, and/or generate an alert when a detected identifier does not match an expected identifier.

In the example shown in FIG. 2A, the electronic device 210 can further include a pressure sensor 260 positioned proximate to the connector 225. The pressure sensor 260 can be positioned proximate to a connector interface of the connector 225, e.g., within a connector housing, on a printed circuit board region adjacent the connector 225, or at another location where the pressure sensor 260 can be contacted or loaded by a portion of an inserted cable connector.

In some implementations, the pressure sensor 260 can include a piezoresistive element having an electrical impedance that varies with an applied force. In some cases, the pressure sensor 260 can be implemented using other sensor structures, such as a piezoelectric sensor, a force-sensitive resistor (FSR), a strain gauge, a capacitive force sensor, a mechanical switch, an optical interrupter, or another sensor structure configured to generate a signal indicative of an insertion or a seating.

When a cable (e.g., the cable 180 of FIG. 1) is inserted into the connector 225, the pressure sensor 260 can generate an output indicative of an insertion status. In the example shown in FIG. 2A, the pressure sensor 260 provides an analog output that is processed via a signal chain including an amplifier 265 and an analog-to-digital converter (ADC) 270. The amplifier 265 can be implemented by an instrumentation amplifier, an operational amplifier, a transimpedance amplifier, or another analog front-end circuit configured to amplify, bias, filter, and/or linearize a sensor output. The ADC 270 can digitize a conditioned sensor output and provide a digital sensor signal to the management controller 240. The ADC 270 can be integrated into the management controller 240, integrated into the pressure sensor 260, or omitted when the pressure sensor 260 provides a digital output. In some cases, the ADC 270 can be implemented by an existing analog-to-digital conversion component of the electronic device 210, such as an ADC peripheral of a BMC or a microcontroller of a server platform.

The management controller 240 is communicatively coupled to both the RFID reader 230 and the ADC 270. To determine an overall connection state for the connector 225, the management controller 240 can aggregate data from both an RFID detection path and a pressure sensing path. For example, the management controller 240 can process the digital sensor signal to evaluate whether the cable is not inserted, partially inserted, or fully inserted. In some implementations, the management controller 240 utilizes two thresholds, T1 and T2 (where T2 > T1), to differentiate these insertion states. For example, when the measured pressure (or corresponding digital sensor value) is less than T1, the management controller 240 can determine that the cable is not inserted; when the measured pressure is between T1 and T2, the management controller 240 can determine that the cable is partially inserted (e.g., loosely connected); and when the measured pressure is greater than T2, the management controller 240 can determine that the cable is fully inserted (e.g., completely seated). In some cases, the management controller 240 can additionally apply temporal criteria, such as requiring the measured pressure to remain above T1 and/or T2 for at least a threshold duration, to reduce false readings caused by transient contact, vibration, or insertion motion. Furthermore, to maintain long-term accuracy, the management controller 240 can perform calibration and drift compensation, which may include storing a baseline sensor value, applying temperature compensation, and/or dynamically adapting one or more threshold values based on historical measurements.

The management controller 240 can combine the insertion status determined from the pressure sensor 260 with the RFID information from the RFID reader 230 to generate an output signal indicative of a connection integrity. For example, the management controller 240 can indicate a valid connection state when the insertion status is fully inserted and a matching RFID tag is detected, and can indicate an incorrect cable or a mismatch state when the insertion status indicates an insertion while the tag identifier does not match the expected identifier. The management controller 240 can indicate a reverse-insertion fault condition when the insertion status indicates the fully inserted state while the RFID tag is not detected.

Although FIG. 2A illustrates one connector 225 with one RFID detection path and one pressure sensing path, the electronic device 210 can include a plurality of connectors and a plurality of respective sensors. For example, the electronic device can include a plurality of connectors each having a respective antenna and RFID tag pairing (and, optionally, a respective pressure sensor) such that the management controller 240 determines a connection state for each connector independently.

FIG. 2B illustrates a schematic diagram of the example system 200, which can be same as or similar to the system of FIG. 1. The system 200 can include the electronic device 210 of FIG. 2A on a server circuit board 202. In particular, FIG. 2B illustrates how identification sensing (RFID) and insertion sensing (pressure) can be integrated around a board-mounted connector for cable connection monitoring. In the illustrated implementation, a first connector 225, e.g., a board-mounted receptacle connector, is mounted on the server circuit board 202, e.g., a printed circuit board to receive a cable connector at a terminal end of a cable 280 (e.g., the cable 180 of FIG. 1). The cable-side connector can include an RFID tag 290 (e.g., the RFID tag 190 of FIG. 1) disposed proximate to the connector interface such that, when the cable connector is fully mated with the board connector, the RFID tag is positioned within a short communication range of an antenna located adjacent the board connector. In some implementations, a metal cover or shield 204 is disposed over or at least partially covering the RFID tag (and/or over the board-side antenna region) to reduce coupling to adjacent tags and to promote directional, localized RFID communication.

FIG. 2B further illustrates an insertion-sensing path that complements the RFID identification path. For example, a pressure sensor 260 (e.g., a piezoresistive element) can be positioned at or near the connector interface such that insertion and seating of the cable connector produces an applied force that changes an electrical characteristic of the sensor. The sensor output can be provided to an analog front end, such as an amplifier 265, which conditions the sensor signal for subsequent digitization and processing (e.g., via an ADC as shown in FIG. 2A, or via another digital sampling path). In parallel, the board-side antenna 235 is electrically coupled to an RFID reader 230 that interrogates the RFID tag and provides identification data, such as a detection indication and/or a decoded tag identifier.

As in FIG. 1 and FIG. 2A, a management controller 240 (e.g., a BMC) can include a logic unit 242 configured to receive the RFID reader output (e.g., via SPI or another serial interface) and receive the pressure-sensing output (e.g., via an ADC interface, GPIOs, or another signal interface) and combine the two inputs to determine a connection state for the connector. Based on the determined connection state, the management controller 240 can control an output component, such as an indicator LED 250, to provide a visual indication of the connection status.

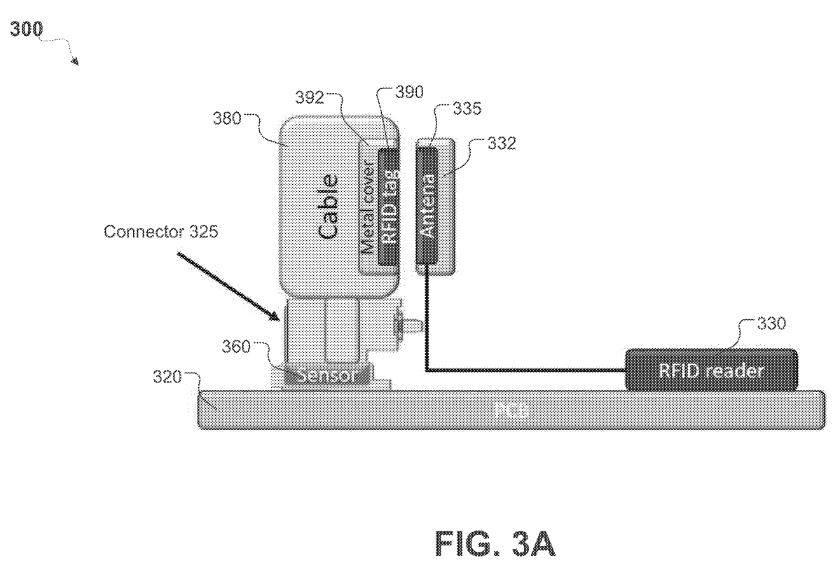

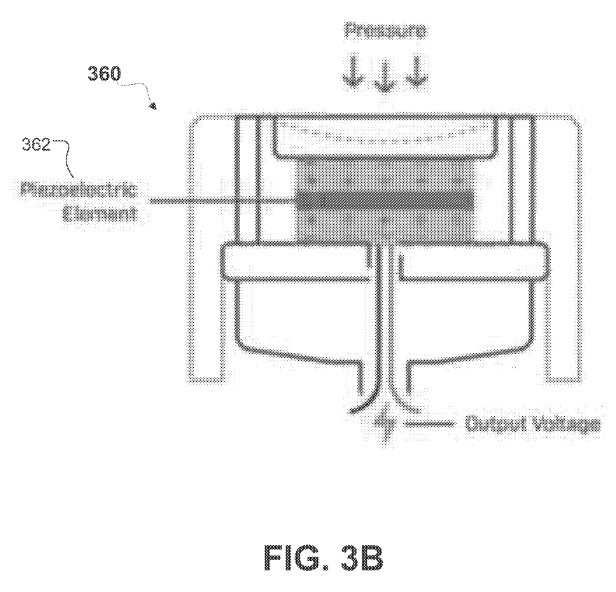

FIG. 3A illustrates a side view of an example connector region on a printed circuit board (PCB) that can be implemented in a system 300 such as the system 100 of FIG. 1 or the system 200 of FIGS. 2A or 2B. In the illustrated implementation, a board-mounted first connector 325 is disposed on a PCB 320, and a cable-side second connector at a terminal end of a cable is mechanically engaged with the first connector in a mated configuration. In the example shown in FIG. 3A, the RFID tag 390 is positioned on (or within) the cable-side connector, and is close to a board-side antenna 335 when the connectors are fully seated. Additionally, a metal cover 392 may at least partially enclose the RFID tag 390 to promote directional communication, while another shield 332 may be provided for the antenna 335.

FIG. 3A also shows that the antenna 335 is electrically coupled to an RFID reader 330 to interrogate the tag 390 and obtain a detection indication and/or a decoded tag identifier, as described with respect to FIG. 1. Further, a pressure sensor 360 can be positioned at or near the connector interface (e.g., under the connector 325 or within the connector structure) to generate a signal indicative of insertion and seating, enabling a management controller to combine the RFID identification result with an insertion-status result to determine an overall connection state.

FIG. 3B illustrates an example sensor structure that can be used to implement the pressure sensor 260 described herein (e.g., with reference to FIG. 2A) and that can be deployed proximate to a connector interface as shown in FIG. 1. In the illustrated cross-sectional view, the pressure sensor includes a sensing element, e.g., a piezoelectric element, positioned to experience a compressive force when a cable-side connector is inserted into and seated within a board-side connector. The applied force (schematically shown by downward arrows) can be generated, for example, by mechanical engagement of the mated connectors and/or by a retention feature that loads the sensing element when the connector reaches a seated position.

The sensing element generates an electrical output in response to mechanical deformation. For example, the sensing element can include a piezoresistive or other force-sensitive resistive material whose resistance varies with applied force (e.g., compression at the connector interface). The sensing element may be coupled in a voltage-divider (or bridge) circuit such that the resistance variation can produce a corresponding change in an output voltage. FIG. 3B provides an illustrative example of how a mechanical force applied at the connector interface can be converted into an electrical signal indicative of insertion and seating.

Electrical conductors coupled to the pressure sensor (e.g., leads shown at the bottom of FIG. 3B) can provide the sensor output to downstream circuitry for conditioning and digitization. For example, as described with respect to FIG. 2A, the sensor output can be provided to an analog front-end circuit (e.g., an amplifier) and an ADC (e.g., an ADC) to generate a digitized sensor signal. A management controller can then evaluate the digitized sensor signal to determine an insertion status, such as not inserted, partially inserted, or fully inserted, for example, by comparing the digitized value to one or more thresholds.

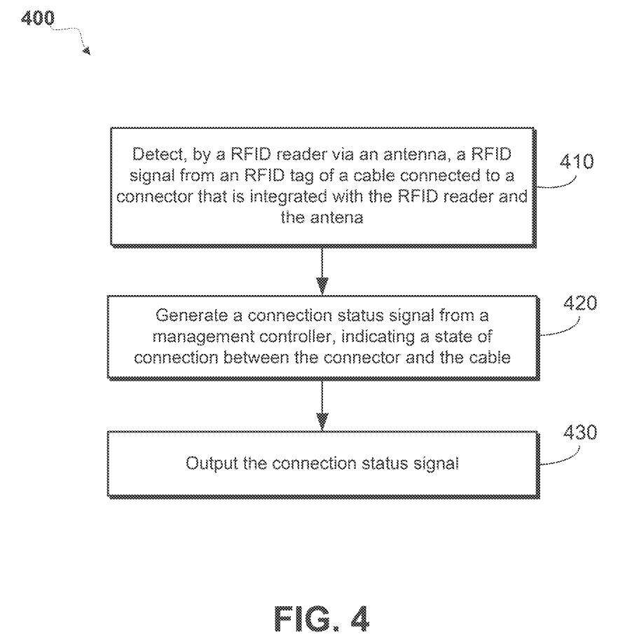

FIG. 4 is a flowchart of an example process 400 for managing (e.g., monitoring and characterizing) a cable connection status for an electronic device, such as the electronic device 110 described with reference to FIG. 1 or the electronic device 210 described with reference to FIG. 2A. The process 400 can be performed by a system including the electronic device, e.g., the system 100 of FIGS. 1, 200 of FIG. 2A or 2B, or 300 of FIG. 3A.

At 410, an RFID reader (e.g., the RFID reader 130 of FIG. 1, 230 of FIGS. 2A-2B, or 330 of FIG. 3A) of the electronic device detects an RFID signal from an RFID tag (e.g., the RFID tag 190 of FIG. 1, 290 of FIGS. 2B, 390 of FIG. 3A), of a cable (e.g., the cable 180) via an antenna (e.g., the antenna 135 or 235) of the electronic device. The antenna can be disposed proximate to a first connector (e.g., the first connector 125 or 225). For example, the antenna can be disposed within a first distance to a connector interface of the first connector, where the first distance is within a communication range of the antenna. The detection can occur when a second connector of the cable is mechanically mated to the first connector. The RFID signal can include a tag identifier that allows a system to distinguish between a plurality of cables, or the RFID signal can specifically indicate whether a matching RFID tag is detected. The RFID tag may operate passively by drawing a power from an electromagnetic field generated by the antenna.

In some implementations, the RFID tag is at least partially enclosed by a metal shield defining an opening oriented toward the antenna, and/or the antenna is at least partially enclosed by another metal shield defining another opening oriented toward the tag-side opening, such that wireless communication primarily occurs through the opening(s) when the connectors are mated.

At 420, a management controller (e.g., the management controller 140 or 240) generates an output signal indicating a state of a connection between the first connector and the second connector. In some implementations, the RFID signal includes a tag identifier, and the management controller compares the tag identifier to an expected identifier associated with the first connector and sets the output signal to include a flag indicating a matched condition or an unmatched condition.

The management controller can generate the output signal based at least on the RFID signal received from the RFID reader. Furthermore, the management controller may further use a sensor signal received from a pressure sensor to generate the output signal. The pressure sensor can detect a physical force applied by the second connector and generate the sensor signal indicative of an insertion status. For example, the management controller can determine the insertion status as not inserted, partially inserted, or fully inserted based on the sensor signal satisfying one or more thresholds. An amplifier (e.g., the amplifier 265) and an analog-to-digital converter (ADC) (e.g., the ADC 270) can convert an analog output of the pressure sensor into the sensor signal. As described with reference to FIG. 2A, by evaluating both signal types, the management controller can determine the insertion status and identify a specific state such as a valid connection state or a reverse-insertion fault condition. For example, the management controller can determine a reverse-insertion fault condition in response to (i) the sensor signal indicating the second connector is in a fully inserted state and (ii) the RFID signal indicating that the RFID tag is not detected, and can determine a valid connection state in response to (i) the sensor signal indicating the fully inserted state and (ii) the RFID signal indicating that a matching RFID tag is detected.

At 430, an output component (e.g., the output component 150 or 250) of the electronic device outputs an indication of the state of the connection based on the output signal. The output component can provide the indication by driving a light indicator (e.g., an LED), updating a display device, providing an audible output, or transmitting the output signal over a network interface to a remote device. By providing a real-time feedback, the process 400 can enable a rapid identification and a diagnosis of a cable connectivity issue within a complex electronic system.

In implementations with multiple connectors (including multi-board platforms), steps 410–430 can be repeated for each connector/cable pair to generate respective output signals and drive respective output components.

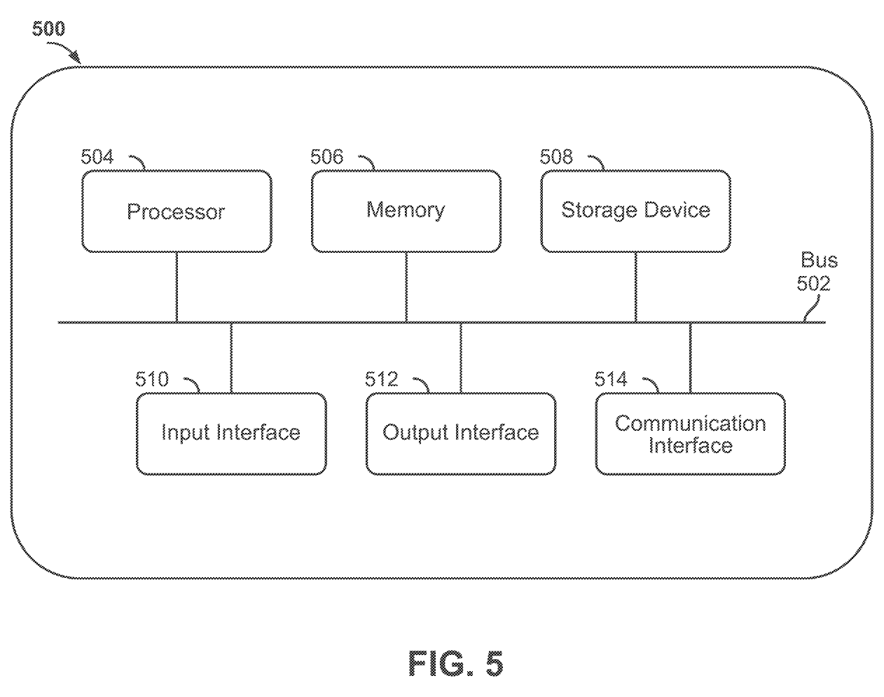

FIG. 5 illustrates an example architecture of a computing device 500, which can be an implementation of the electronic device 110 described in the system 100 of FIG. 1, or the electronic device 210 of FIG. 2A. The computing device 500 includes a processor 504, memory 506, a storage component 508, an input interface 510, an output interface 512, and a communication interface 514, all communicatively coupled via a bus 502. The bus 502 can represent the electrical pathways on one or more circuit boards of the electronic device (e.g., circuit board 120 and/or circuit board 220).

Processor 504 can represent integrated circuitry on one or more circuit boards, such as one or more central processing units (CPUs), a graphics processing unit (GPU), a Baseboard Management Controller (BMC), a Complex Programmable Logic Device (CPLD), and/or other processing circuitry. This integrated circuitry can generate and process signals used to perform one or more processes described herein, for example, receiving identification data from an RFID reader and receiving sensor data from a pressure sensing path, and generating output signals indicative of a connection state. Memory 506 and storage component 508 can include various forms of computer-readable media for storing data and software instructions.

The input interface 510 and output interface 512 can collectively represent interface components described herein. For example, the input interface 510 can include components and/or interfaces used to receive information, such as a serial interface coupled to an RFID reader (e.g., SPI, I2C, or UART) and/or an interface used to receive a pressure sensor signal (e.g., an ADC interface or GPIO pins). The output interface 512 can include components used to provide output information, such as one or more light indicators (e.g., LEDs), a display device, and/or an audible output device. The communication interface 514 can include components such as a network management interface configured to transmit connection-state information to a remote device.

In operation, the processor 504 can execute software instructions stored in memory 506 or storage component 508 to perform one or more processes described herein. In some implementations, hardwired circuitry, such as the CPLD, can be used in place of or in combination with software instructions. The number and arrangement of components illustrated in FIG. 5 are provided as an example, and other configurations are possible.

Bus 502 includes a component that permits communication among the components of the computing device 500. In some embodiments, processor 504 is implemented in hardware, software, or a combination of hardware and software. In some examples, processor 504 includes a processor (e.g., a central processing unit (CPU), a graphics processing unit (GPU), an accelerated processing unit (APU), and/or the like), a digital signal processor (DSP), and/or any processing component (e.g., a field-programmable gate array (FPGA), an application specific integrated circuit (ASIC), and/or the like) that can be programmed to perform at least one function. Memory 506 includes random access memory (RAM), read-only memory (ROM), and/or another type of dynamic and/or static storage device (e.g., flash memory, magnetic memory, optical memory, and/or the like) that stores data and/or instructions for use by processor 504.

Storage component 508 stores data and/or software related to the operation and use of the computing device 500. In some examples, storage component 508 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 510 includes a component that permits the computing device 500 to receive information, such as via user input (e.g., a touchscreen display, a keyboard, a keypad, a mouse, a button, a switch, a microphone, a camera, and/or the like). Additionally or alternatively, in some embodiments input interface 510 includes a sensor that senses information (e.g., a global positioning system (GPS) receiver, an accelerometer, a gyroscope, and/or the like). Output interface 512 includes a component that provides output information from the computing device 500 (e.g., a display, a speaker, one or more light-emitting diodes (LEDs), and/or the like).

In some embodiments, communication interface 514 includes a transceiver-like component (e.g., a transceiver, a separate receiver and transmitter, and/or the like) that permits the computing device 500 to communicate with other devices via a wired connection, a wireless connection, or a combination of wired and wireless connections. In some examples, communication interface 514 permits the computing device 500 to receive information from another device and/or provide information to another device. In some examples, communication interface 514 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, the computing device 500 performs one or more processes described herein. The computing device 500 performs these processes based on processor 504 executing software instructions stored by a computer-readable medium, such as memory 506 and/or storage component 508. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 506 and/or storage component 508 from another computer-readable medium or another device via communication interface 514. When executed, software instructions stored in memory 506 and/or storage component 508 cause processor 504 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 506 and/or storage component 508 includes data storage or at least one data structure (e.g., a database and/or the like). The computing device 500 is capable of receiving information from, storing information in, communicating information to, or searching information stored in the data storage or the at least one data structure in memory 506 or storage component 508. In some examples, the information includes network data, input data, output data, or any combination thereof.

In some embodiments, the computing device 500 is configured to execute software instructions that are either stored in memory 506 and/or in the memory of another device (e.g., another device that is the same as or similar to the computing device 500). As used herein, the term “module” refers to at least one instruction stored in memory 506 and/or in the memory of another device that, when executed by processor 504 and/or by a processor of another device (e.g., another device that is the same as or similar to the computing device 500) cause the computing device 500 (e.g., at least one component of the computing device 500) to perform one or more processes described herein. In some embodiments, a module is implemented in software, firmware, hardware, and/or the like.

The number and arrangement of components illustrated in FIG. 5 are provided as an example. In some embodiments, the computing device 500 can include additional components, fewer components, different components, or differently arranged components than those illustrated in FIG. 5. Additionally or alternatively, a set of components (e.g., one or more components) of the computing device 500 can perform one or more functions described as being performed by another component or another set of components of the computing device 500.

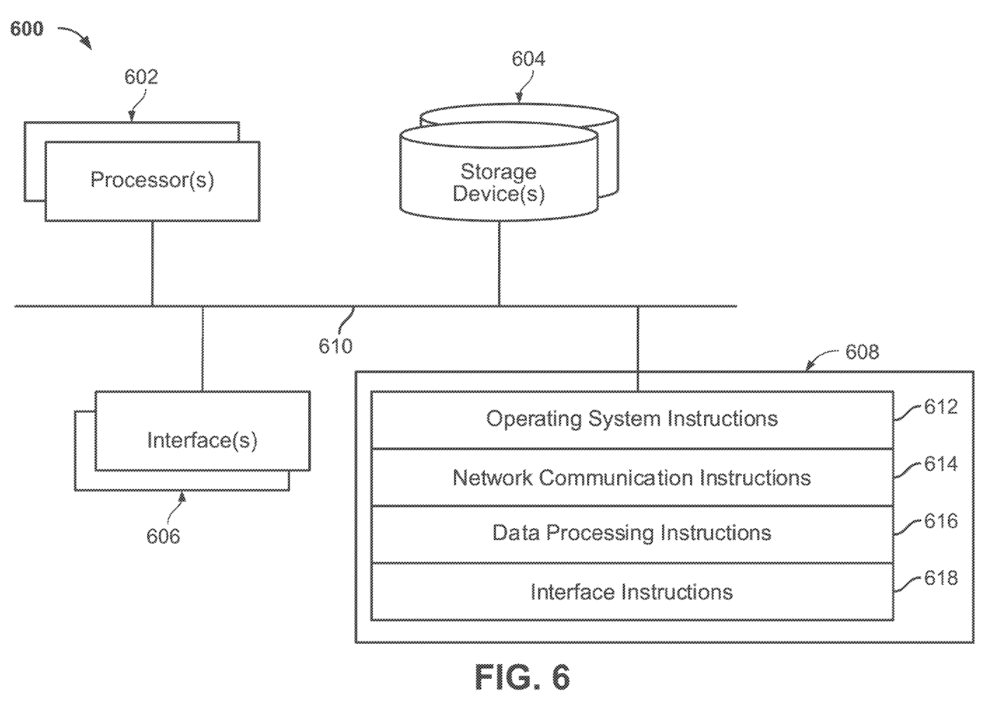

FIG. 6 illustrates an example architecture 600 of a computing system, such as a server, which can incorporate the cable connection detection components and techniques described in FIGS. 1-3B. The computing system 600 provides a broader context for the previously described components. Other architectures are possible, including architectures with more or fewer components.

The architecture 600 can include one or more processors 602, one or more storage devices 604, one or more network interfaces 606, and one or more computer-readable media 608. These components can exchange communications and data over one or more communication channels 610 (e.g., one or more buses), such as the bus 502 described with reference to FIG. 5. The processor(s) 602 can include integrated circuitry described previously, such as a CPU and/or a management controller (e.g., a BMC) that can implement one or more processes described herein. The network interface(s) 606 can include a network management interface configured to transmit connection-state information and/or diagnostic information to a remote device, and the storage device(s) 604 can include one or more local storage devices.

The term “computer-readable medium” refers to a non-transitory medium that participates in providing instructions to the processor(s) 602 for execution, including non-volatile media (e.g., optical or magnetic disks) and volatile media (e.g., memory). The computer-readable medium(s) 608 can store various instructions, including an operating system 612, a network communications module 614, data processing instructions 616, and interface instructions 618.

Operating systems can perform basic tasks, for example, recognizing input from and providing output to devices, and managing traffic on the communication channels. The network communications module 614 can manage data transfer through interfaces such as the network management interface using communication protocols (e.g., TCP/IP, HTTP). Data processing instructions 616 include software for implementing one or more processing operations described herein. Furthermore, the interface instructions 618 can include firmware and/or software for a management controller to interface with the sensor paths and manage input and output functions. This includes receiving RFID reader data, receiving pressure sensor data, generating connection-state information, and controlling one or more output components (e.g., indicator LEDs) and/or transmitting connection-state information to remote devices.

The architecture 600 can be implemented in various configurations, including as a single server or as part of a larger system, such as a cloud computing environment with multiple server computers in a local or distributed network each having one or more processing cores. Architecture 600 can be implemented in a parallel processing or peer-to-peer infrastructure or on a single device with one or more processors. Each server can implement the cable connection detection system to improve assembly verification, monitoring, and service diagnostics within the larger infrastructure. Software can include multiple software components or can be a single body of code.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non‑transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage media. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual’s action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application‑specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand‑alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub‑programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto‑optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer‑readable media for storing computer program instructions and data can include all forms of permanent/non-permanent or volatile/non‑volatile memory, media and memory devices, including by way of example semiconductor memory devices, for example, random access memory (RAM), read‑only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto‑optical disks; and optical memory devices, for example, digital versatile/video disc (DVD), compact disc (CD)‑ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user’s mobile computing device in response to requests received from the web browser).

The term “graphical user interface” (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back‑end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back‑end, middleware, or front‑end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

It is noted that references in the present disclosure to “one embodiment,” “an embodiment,” “an example embodiment,” “some implementations,” “some implementations,” etc., indicate that the embodiment described can include a particular feature, structure, or characteristic, but every embodiment can not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to affect such feature, structure or characteristic in connection with other implementations whether or not explicitly described.

As used herein, the term “nominal/nominally” refers to a desired, or target, value of a characteristic or parameter for a component or a process step, set during the design phase of a product or a process, together with a range of values above and/or below the desired value. As used herein, the range of values can be due to slight variations in manufacturing processes or tolerances.

As used herein, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or, A and B.” As used herein, the term “and/or” as used herein refers to and encompasses any and all possible combinations of one or more of the associated listed terms. For example, the term “A and/or B” means that either option A, option B, or both options A and B are possible, where A and B may be singular or plural.

As used herein, the term “based on” can be directly based on or indirectly based on. For example, the phrase “based on a voltage” can be interpreted to cover: i) directly based on the voltage; i) indirectly based on the voltage, e.g., directly based on a signal (or voltage) that is generated based on (either directly or indirectly) the voltage. As used herein, the term “about” or “approximately” can allow for a degree of variability in a value or range, for example, within 10%, within 5%, or within 1% of a stated value or of a stated limit of a range. As used herein, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

In addition, the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The breadth and scope of the present disclosure should not be limited by any of the above-described exemplary implementations, but should be defined only in accordance with the following claims and their equivalents.

1. An electronic device, comprising:
a first connector comprising a first connector interface configured to mechanically mate with a second connector interface of a cable;
a radio frequency identification (RFID) reader;
an antenna electrically coupled to the RFID reader and disposed proximate to the first connector interface, wherein the antenna is configured to wirelessly communicate with an RFID tag of the cable when the first connector interface is in a mated configuration with the second connector interface; and
a management controller communicatively coupled to the RFID reader; wherein the management controller is configured to generate an output signal indicating a state of a connection between the first connector and the cable based at least on an RFID signal received from the RFID reader identifying the RFID tag.

2. The electronic device of claim 1, wherein the antenna is configured to face a first opening of a first metal shield disposed over the RFID tag when the first connector interface is in a mated configuration with the second connector interface.

3. The electronic device of claim 1, wherein the antenna is disposed within a first distance to the first connector interface, and the first distance is within a communication range of the antenna.

4. The electronic device of claim 1, wherein the antenna is configured to generate an electromagnetic field that powers the RFID tag when the first connector interface is in a mated configuration with the second connector interface.

5. The electronic device of claim 1, wherein the RFID reader is configured to generate the RFID signal to indicate whether a matching RFID tag is detected by the RFID reader.

6. The electronic device of claim 1, wherein the RFID reader is configured to generate the RFID signal to include a tag identifier corresponding to an identifier of a detected RFID tag.

7. The electronic device of claim 6, wherein the management controller is configured to determine whether the tag identifier matches an expected identifier associated with the first connector, and to generate the output signal to include a flag indicating a matched condition or an unmatched condition.

8. The electronic device of claim 1, wherein the electronic device further comprises a pressure sensor positioned proximate to the first connector interface, and the pressure sensor is configured to detect a physical force applied by the second connector and generate a sensor signal indicative of an insertion status of the second connector based on the detected physical force, and
wherein the management controller is configured to generate the output signal based on both the RFID signal and the sensor signal.

9. The electronic device of claim 8, wherein the pressure sensor comprises a piezoresistive element having an electrical impedance that varies in response to the physical force applied by the second connector.

10. The electronic device of claim 8, wherein the pressure sensor is mounted on a printed circuit board that supports the first connector, and is positioned to be contacted by a portion of the second connector when the second connector is in the mated configuration.

11. The electronic device of claim 8, wherein the electronic device further comprises a signal conditioning circuit electrically coupled between the pressure sensor and the management controller, and
wherein the signal conditioning circuit is configured to convert an analog output of the pressure sensor into the sensor signal.
(X3) The electronic device of claim 11, wherein the signal conditioning circuit comprises an amplifier and an analog to digital converter (ADC).

12. The electronic device of claim 8, wherein the management controller is configured to determine the insertion status as one of being not inserted, being partially inserted, or being fully inserted based on the sensor signal satisfying one or more thresholds.

13. The electronic device of claim 8, wherein the management controller is configured to determine a reverse-insertion fault condition in response to (i) the sensor signal indicating the second connector is in a fully inserted state, and (ii) the RFID signal indicating that the RFID tag is not detected.

14. The electronic device of claim 8, wherein the management controller is configured to generate the output signal indicating a valid connection state in response to (i) the sensor signal indicating that the second connector is in a fully inserted state; and (ii) the RFID signal indicating that a matching RFID tag is detected.

15. The electronic device of claim 1, wherein the electronic device further comprises an output component configured to receive the output signal from the management controller and to provide an indication of the state of the connection based on the received output signal.

16. The electronic device of claim 15, wherein the output component comprises one or more of: one or more light indicators, a display device, an audible output device, or a network interface configured to transmit the output signal to a remote device.

17. The electronic device of claim 15, wherein the output component is a first output component, and the electronic device comprises:
a first circuit board, wherein the first connector, the RFID reader, and the antenna are integrated on the first circuit board;
a second circuit board, wherein a third connector, a second RFID reader, and a second antenna are integrated on the second circuit board, and the third connector is configured to be connected with a fourth connector of a second cable;
a second output component configured to receive a second output signal from the management controller to provide an indication of a state of connection between the third connector and the fourth connector; and
an electrical board, wherein the management controller, the first output component, and the second output component are integrated on the electrical board.

18. The electronic device of claim 1, wherein the electronic device comprises a computing system, and wherein the management controller is implemented by a baseboard management controller (BMC) of the computing system.

19. A system, comprising:
an electronic device comprising:
a first connector comprising a first connector interface;
a radio frequency identification (RFID) reader;
an antenna electrically coupled to the RFID reader and disposed proximate to the first connector interface; and
a management controller communicatively coupled to the RFID reader; and
a cable comprising:
a second connector comprising a second connector interface configured to mechanically mate with the first connector interface; and
an RFID tag disposed proximate to the second connector interface,
wherein, when the second connector interface is mechanically coupled to the first connector interface in a mated configuration, the RFID reader is configured to wirelessly communicate with the RFID tag via the antenna, and
wherein the management controller is configured to generate an output signal indicating a state of a connection between the first connector and the second connector based at least on an RFID signal from the RFID reader.

20. A method performed by an electronic device, the method comprising:
detecting, by a radio frequency identification (RFID) reader of the electronic device via an antenna of the electronic device, an RFID signal from an RFID tag of a cable, the antenna being disposed proximate to the first connector;
generating, by a management controller of the electronic device, an output signal indicating a state of a connection between the first connector and a second connector of the cable based at least on the RFID signal; and
outputting, by an output component of the electronic device, an indication of the state of the connection.
